(19) United States
(12) Patent Application Publication
(10) Pub. No.: US 2023/0155451 A1
(43) Pub. Date: May 18, 2023

(54) GENERATOR SYSTEM UTILIZING WEIGHTS OF RECURRENT STATIC LOADS

(71) Applicant: Musbah Ali Lahib, Sharjah (AE)

(72) Inventor: Musbah Ali Lahib, Sharjah (AE)

(21) Appl. No.: 18/097,899

(22) Filed: Jan. 17, 2023

Related U.S. Application Data
(63) Continuation-in-part of application No. 17/264,906, filed on Feb. 1, 2021.

(51) Int. Cl. H02K 7/18; H02K 7/10; H02K 7/116

(52) U.S. Cl. CPC H02K 7/1853; H02K 7/1004; H02K 7/116

(57) ABSTRACT

A generator system includes a system configured to support a load, the system including a stationary lower support and an upper support capable of moving in an upward and a downward direction. The system includes at least a first folding support and a second folding support positioned on opposite ends of the system between the upper support and the lower support, a gear rack assembly positioned at a midpoint of the system between the first folding support and the second folding support. The gear rack assembly includes an upper gear rack connected to the first folding support, a lower gear rack connected to the second folding support, and a gear for engaging the upper gear rack and the lower gear rack. A shaft connected to a dynamo is configured to rotate with the gear, converting rotational movement to electrical power.

### CROSS-REFERENCE TO RELATED APPLICATION

This application is a Continuation-in-part of, and claims priority to, U.S. patent application Ser. No. 17/264,906, filed Feb. 1, 2021, which claims priority to International Patent Application No. PCT/IB2018/000820, filed on Aug. 2, 2018, the contents of both of which are incorporated herein by reference in their entirety.

### TECHNICAL FIELD

This disclosure relates generally to a generator system utilizing the weight of recurrent static loads to generate power.

### BACKGROUND

There is a growing need for clean and sustainable energy resources as problems associated with climate change and diminishing non-renewable resources increase. For example, such a need exists due to the current dependence on fossil fuels for power generation, which is causing their depletion and is known to negatively impact the ecosystem. Therefore, and due to the ever-changing demand for clean and sustainable energy, technologies for harvesting readily available, clean, and sustainable energy are needed. Solar power, wind turbines, and hydroelectricity now exist for energy production, but present their own individual problems, such as with the need to consume valuable real estate to build and operate (i.e., farmland or other real estate consumed for wind and solar farms, land that is consumed when a hydroelectric plant is built and the resulting flowage, and the like).

Recurrent static loads are found around us every day. Particularly surrounding industries related to shipping and storing goods, static loads may be found in locations not limited to warehouses, ports, and parking lots. Known in the art are devices which generate electricity from downward forces, however only a fraction of the load's movement is utilized for power generation. It would be beneficial to take advantage of loads that undergo recurrent loading and unloading to generate power.

Where recurrent static loads are found, known existing infrastructure may be present. For example, bridges and loading systems exist in locations where recurrent static loads such as automobiles or cargo are frequently found. It would be beneficial to take advantage of existing infrastructure and/or real estate of the existing infrastructure to build power generation systems. For instance, a bridge may be built with the generator system of the disclosure and be contained to the space where a bridge already exists, requiring no additional real estate which may be valuable and expensive. Additionally, where more expansive electricity is not available or may be limited, particularly in remote areas, local systems can be critical for providing necessary electricity.

Therefore, a need exists for an improved power generation system for generating electricity.

### BRIEF DESCRIPTION

According to the disclosure, a generator system configured to support a load and create electrical power includes a plurality of folding supports, a gear rack assembly positioned at a midpoint of the system, and a generator assembly. The system includes an upper support movable in an upward and a downward direction and a lower support that is fixed and extends parallel to the upper support. The plurality of folding supports includes at least two corresponding pairs of scissor arms, an upper track and a lower track, and a plurality of wheels for connecting the at least two pairs of scissor arms to the upper track and the lower track. The gear rack assembly includes an upper gear rack and a lower gear rack, a gear engaging the upper gear rack and the lower gear rack, and a shaft positioned at a center of the gear for rotating in a one-directional manner with the gear. The generator assembly includes a dynamo, the shaft connected to the dynamo for converting the one-directional rotational movement of the shaft into electrical power. When the load is added to the upper support, a weight of the load lowers the upper support such that the scissor arms expand in a horizontal direction by the plurality of wheels sliding in the upper track and the lower track, and the plurality of wheels push the upper gear rack and the lower gear rack, rotating the gear and the shaft, such that the rotational movement of the shaft is transferred to the dynamo for electrical power generation.

Also according to the disclosure, a system configured to generate power from supporting a load includes a lower support that is stationary and an upper support movable in an upward and a downward direction. The generator system includes at least two folding supports, a first folding support and a second folding support positioned on opposite ends of the system between the upper support and the lower support. The generator system includes a gear rack assembly positioned at a midpoint of the system between the first folding support and the second folding support, the gear rack assembly including an upper gear rack connected to the first folding support, a lower gear rack connected to the second folding support, and a gear for engaging the upper gear rack and the lower gear rack. The generator system includes a generator assembly including a shaft rotatable with the gear, the shaft connected to a dynamo for converting rotational movement of the shaft to electrical power. When the load is added to the upper support, a weight of the load lowers the upper support such that the folding supports expand in a horizontal direction and push the upper gear rack and the lower gear rack, rotating the gear and the shaft, such that the rotational movement of the shaft is transferred to the dynamo for electrical power generation.

According to the disclosure, a method of generating power includes positioning a load on an upper support of a system, the upper support configured to move in a downward direction under weight of the load, compressing a plurality of folding supports, the plurality of folding supports positioned between the upper support and a lower support, pushing a pair of gear racks attached to the plurality of folding supports in a horizontal direction, rotating a gear engaged with the pair of gear racks, rotating a shaft engaged with the gear, the shaft connected to a dynamo, and converting rotational movement of the shaft into electrical power at the dynamo.

### BRIEF DESCRIPTION OF THE DRAWINGS

FIG. 1 is a schematic side view generally illustrating a system used in connection with a generator system.

FIG. 2 is a schematic close-up view generally illustrating a front section of a system used in connection with a generator system.

FIG. 3 is a schematic close-up view generally illustrating a rear section of a system used in connection with a generator system.

FIG. 4 is a schematic close-up view generally illustrating a gear assembly used in connection with a generator system.

FIG. 5 is a schematic close-up view generally illustrating a generator assembly as used in connection with a generator system.

FIG. 6A is a schematic side view generally illustrating a system used in connection with a generator system in an expanded position.

FIG. 6B is a schematic side view generally illustrating a system used in connection with a generator system in a compressed position.

FIG. 7 is a flowchart generally illustrating the operational steps of a generator system where a load L is added.

FIG. 8 is a flowchart generally illustrating the operational steps of a generator system where a load L is removed.

FIG. 9 is a schematic side view generally illustrating an application of a system used in connection with a generator system.

FIG. 10 is a schematic top view generally illustrating an application of a system used in connection with a generator system.

FIG. 11 is a schematic side view generally illustrating an application of a system used in connection with a generator system.

FIGS. 12A-12C are schematic views generally illustrating an application of a system used in connection with a generator system.

### DETAILED DESCRIPTION

Referring now to the discussion that follows and the drawings, illustrative approaches to the disclosed systems and methods are described in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive, otherwise limit, or restrict the claims to the precise forms and configurations shown in the drawings and disclosed in the following detailed description.

This disclosure relates generally to a power generation system that generates power utilizing the weight of recurrent static loads on a system. An exemplary generator system may include a system with an upper support and a lower support. The upper support is configured to receive a load and move in a downward direction under the weight of the load. The generator system includes a plurality of folding supports which compress with the downward movement of the upper support. The generator system includes a gear rack assembly attached to the folding supports. The gear rack assembly is configured to rotate a gear with the compression of the folding supports, such that the rotation of the gear is transmitted via a shaft to a dynamo, providing a sustainable source of power generation.

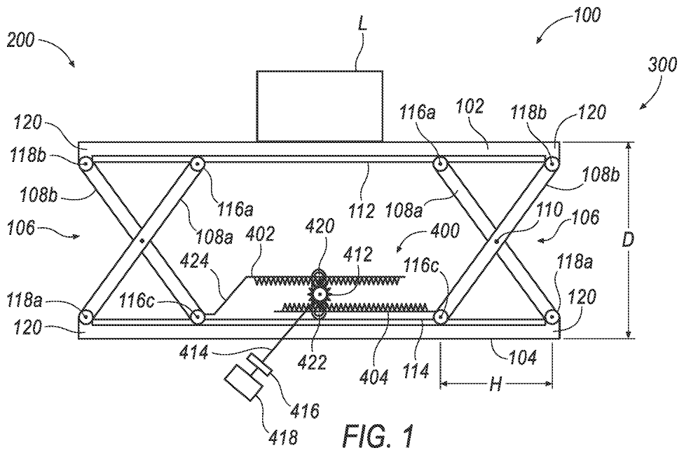

Referring to the figures, FIG. 1 is a schematic side view of a power generation system 100. System 100 includes an upper support 102 and a lower support 104. Upper support 102 and lower support 104 extend in a longitudinal direction, extending parallel to each other with upper support 102 positioned above lower support 104. Lower support 104 is positioned along a surface such as the ground and is stationary, while upper support 102 is movable in an upward or downward movement, such that a distance D between upper support 102 and lower support 104 is increased or reduced with movement of upper support 102, thereby generating gravitational energy to be captured from a load “L” as electrical energy due to the up and down motion.

Upper support 102 and lower support 104 are connected to each other by one or more folding supports 106 at each of a front section 200 and a rear section 300 of system 100. Folding supports 106 are configured to compress and expand upper support 102 and lower support 104. In one example, each folding support 106 includes a set of elongated scissor arms 108a, 108b, a pivotable hinge 110, and a plurality of wheels 116, however other arrangements for compressing and expanding the upper support 102 and lower support 104 may be used. Scissor arms 108a, 108b intersect at their midpoint via pivotable hinge 110. Pivotable hinge 110 facilitates scissor-like movement between scissor arms 108a, 108b as distance D between upper support 102 and lower support 104 increases or is reduced, compressing arms 108a, 108b when distance D is reduced, and expanding arms 108a, 108b when distance D is increased.

Upper support 102 and lower support 104 include an upper track 112 and a lower track 114. Upper track 112 extends along a bottom surface of upper support 102 and lower track 114 extends along a top surface of lower support 104, such that upper track 112 and lower track 114 face inwards toward each other. Scissor arms 108a, 108b are attached at their ends to upper track 112 and lower track 114 via plurality of wheels 116. For example, a first scissor arm 108a is attached to upper track 112 at a first end via a first wheel 116a. A second scissor arm 108b is attached to lower track 114 at a first end via a third wheel 116c. System 100 may include one folding support 106 in each section 200, 300 of system 100 as illustrated in FIG. 1, or system 100 may include any number of folding supports 106 based on factors such as the length of system 100 and the expected weight load to be placed on system 100. For example, a longer system 100 may include more folding supports 106 to extend the length of system 100. Additionally, a system 100 expected to receive a heavy load may include more folding supports 106 to distribute the weight amongst more folding supports 106. System 100 includes at least two folding supports 106, one folding support 106 at each section 200, 300 of system 100.

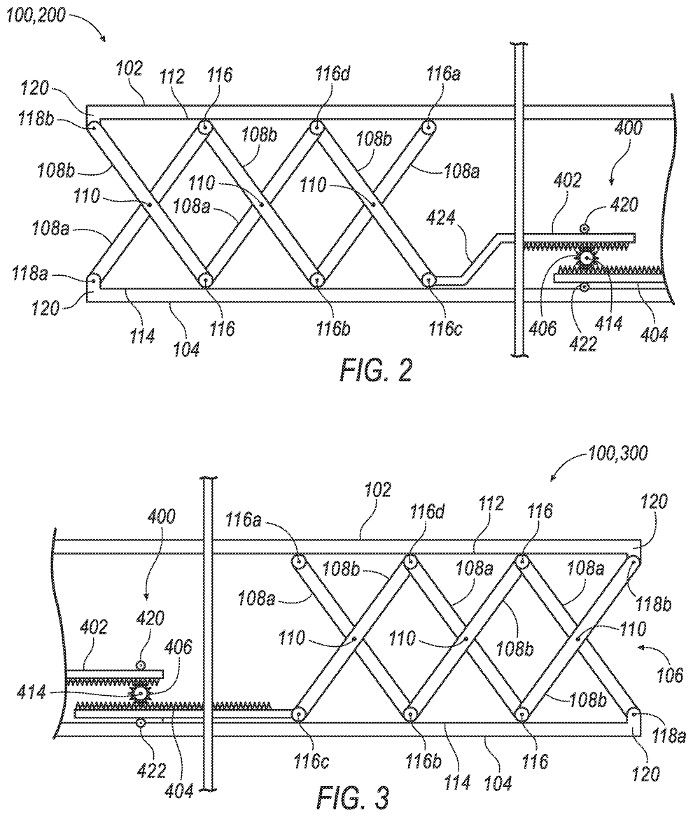

At terminal ends 120 of upper support 102 and lower support 104, scissor arms 108a, 108b are connected to upper support 102 and lower support 104 via fixed hinges 118a, 118b. For example, first scissor arm 108a is attached at a first end to upper support 102 at wheel 116a and at a second end to terminal end 120 of lower support 104 at a first fixed hinge 118a. Second scissor arm 108b is attached at a first end to lower support 104 at wheel 116b and at a second end to terminal end 120 of upper support 102 at a second fixed hinge 118b. In embodiments with more than one pair of scissor arms 108a, 108b per section 200, 300, scissors arms 108a, 108b immediately adjacent to terminal ends 120 include fixed hinge 118a, 118b, while additional scissor arms may include four wheels as illustrated in FIGS. 2 and 3.

System 100 includes the above features at opposite ends of upper support 102 and lower support 104, creating front section 200 and rear section 300. FIG. 2 illustrates a close-up view of front section 200 and FIG. 3 illustrates a close-up view of rear section 300. Front section 200 and rear section 300 meet at a midpoint of system 100 at a gear rack assembly 400. Each of front section 200 and rear section 300 includes at least one folding support 106 for compressing with downward movement of upper support 102.

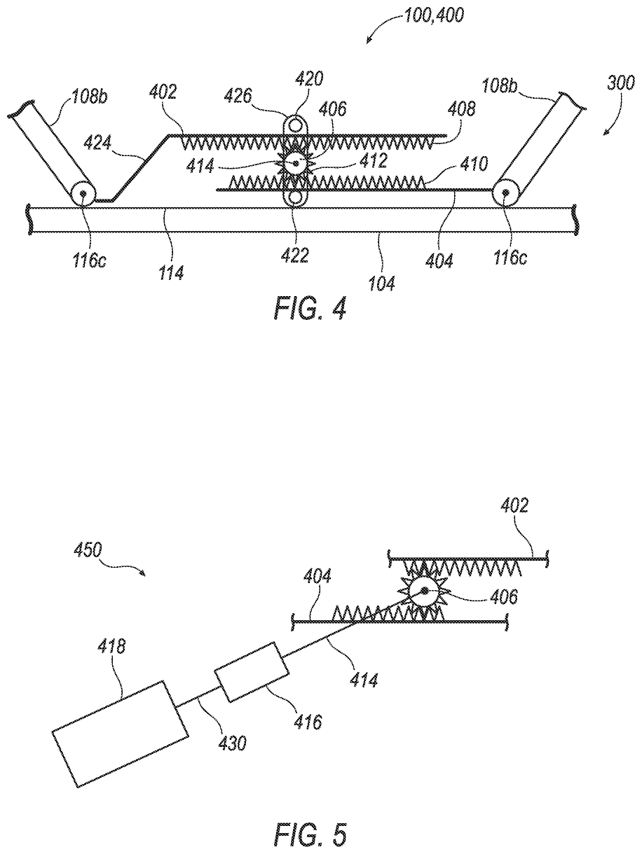

As illustrated in FIG. 4, gear rack assembly 400 includes an upper gear rack 402, a lower gear rack 404, and a gear 406. An inner most wheel 116C on lower support 104 of the rear section 300 is connected to lower gear rack 404. Inner most wheel 116C on lower support 104 of front section 200 is connected to upper gear rack 402. Lower gear rack 404 and upper gear rack 402 extend longitudinally and extend parallel to each other. Lower gear rack 404 extends in the same plane as wheels 116 in lower track 114. Upper gear rack 402 includes a vertical support 424 which extends from wheel 116C such that upper gear rack 402 extends longitudinally above the plane of lower gear rack 404. Upper gear rack 402 includes a plurality of upper rack teeth 408 lining the bottom surface of upper gear rack 402. Lower gear rack 404 includes a plurality of lower rack teeth 410 lining the top surface of lower gear rack 404 such that upper rack teeth 408 and lower rack teeth 410 face toward each other. Gear 406 is a circular gear with a plurality of gear teeth 412 that engage lower rack teeth 410 and upper rack teeth 408.

Upper gear rack 402 includes an upper pulley 420 positioned on a top surface of upper gear rack 402. Lower gear rack 404 includes a lower pulley 422 positioned on a bottom surface of lower gear rack 404. Upper pulley 420 and lower pulley 422 are connected to gear 406 via a belt 426. Belt 426 ensures upper gear rack 402 and lower gear rack 404 remain positioned relative to gear 406. A shaft 414 is illustrated whose operation is further described in FIG. 5, and a generator assembly 450 for converting movement into electrical power.

Illustrated in FIG. 5 is generator assembly 450 for converting movement into electrical power. In the center of gear 406 is shaft 414 which extends through gear 406. As gear 406 rotates, shaft 414 is permitted to rotate. Rotation of shaft 414 is permitted in one direction only, for example, clockwise, such that rotation of gear 406 in an opposite direction, for example, counterclockwise, will not cause rotation of shaft 414 in the opposite direction. Shaft 414 is attached to a dynamo 418 to utilize the rotational movement of shaft 414 for power generation. Shaft 414 is first connected to an automatic transmission box 416 to assist in converting the rotational movement of shaft 414 to power and includes a receiving shaft 430 between automatic transmission box 416 and dynamo 418. In other examples, system 100 may be void of automatic transmission box 416 and shaft 414 may be connected to dynamo 418 without box 416 and receiving shaft 430 such that shaft 414 is directly inputted into dynamo 418. Rotational movement from shaft 414 is inputted into dynamo 418 and dynamo 418 converts mechanical rotation into a pulsing direct electric current that can be utilized for power generation.

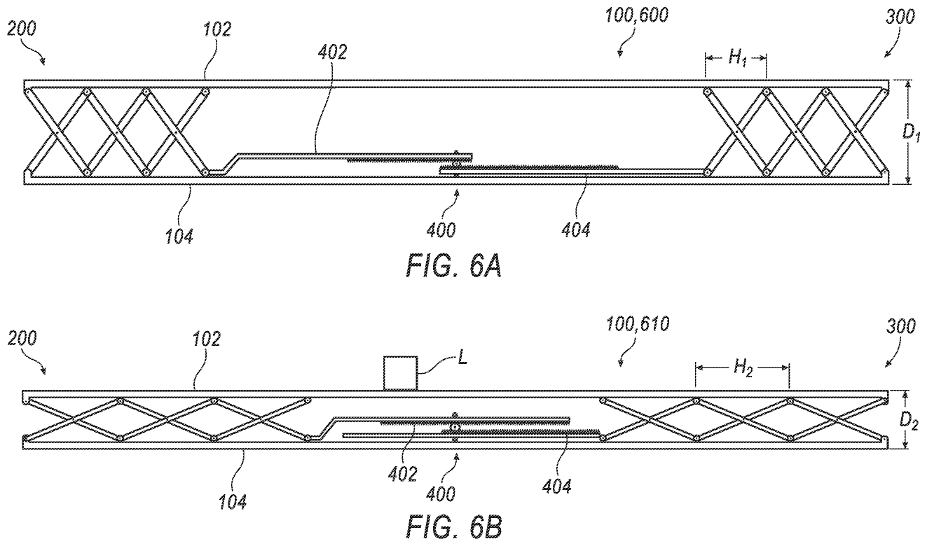

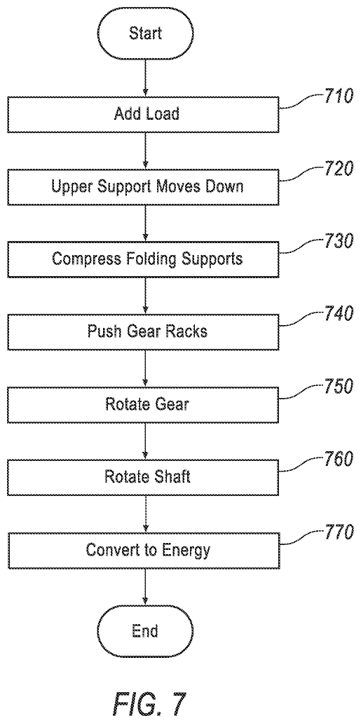

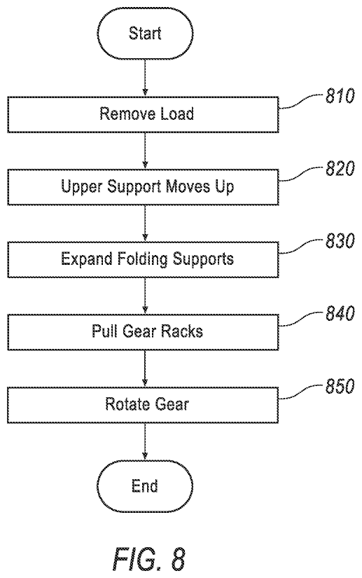

Referring to FIGS. 6A and 6B, system 100 expands and compresses based on added weight of a recurrent static load L. FIG. 6A illustrates a default position of system 100 where no load is added to system 100 and system 100 remains in an expanded position 600. FIG. 6B illustrates a compressed position 610 of system 100 where load L has been added to system 100. FIG. 7 illustrates the steps 700 which occur when load L is positioned on system 100 and system 100 moves from expanded position 600 to compressed position 610 and generates power. FIG. 8 illustrates the steps 800 which occur when load L is removed from system 100 and system 100 moves from compressed position 610 back to expanded position 600.

Referring to FIG. 6A, in the default, expanded position 600, no load L is placed on upper support 102. Upper support 102 is in an upward-most position with the largest distance D1 allowed between upper support 102 and lower support 104. Scissor arms 108a, 108b are in an expanded position such that they extend from upper support 102 to lower support 104, covering distance D1. Horizontal distance H between wheels 116 is reduced to a smaller distance H1 allowed by length of scissor arms 108a, 108b and distance D1 between upper support 102 and lower support 104. In expanded position 600, distance D1 is larger than horizontal distance H1. Upper gear rack 402 and lower gear rack 404 are positioned such that there is limited overlap between upper gear rack 402 and lower gear rack 404.

Referring to FIG. 6B, in the compressed position 610, load L is positioned on upper support 102. Upper support 102 is in a lowered position with a smaller distance D2 allowed between upper support 102 and lower support 104. Scissor arms 108a, 108b are in a compressed positioned such that they extend horizontally. Horizontal distance H between wheels 116 is increased to a larger distance H2 allowed by length of scissor arms 108a, 108b and distance D2 between upper support 102 and lower support 104. In compressed position 610, distance D2 is smaller than horizontal distance H2. Upper gear rack 402 and lower gear rack 404 are positioned such that there is substantial overlap between upper gear rack 402 and lower gear 404.

FIG. 7 is a flowchart generally illustrating the operational steps of a generator system where load L is added. Referring to FIG. 7, the weight of load L carried on system 100 causes compression of system 100 thereby extending scissor arms 108a, 108b by moving wheels 116 on tracks 112, 114 and pushing gear racks 402, 404 horizontally, which subsequently causes the rotation of gear 406 and shaft 414.

At 710, load L is positioned on upper support 102 of system 100. At 720, its weight causes upper support 102 to begin to move in a downward direction. At 730, downward movement of upper support 102 causes folding supports 106 to compress. Compression of folding supports 106 includes scissor arms 108a, 108b pivoting about pivotable hinge 110 to compress to distance D2 between upper support 102 and lower support 104. Wheels 116 slide in upper track 112 and lower track 114 to extend to horizontal distance H2 between adjacent wheels 116. At 740, as wheels 116 slide along tracks 112, 114, wheels 116C attached to gear rack assembly 400 cause upper gear 402 and lower gear rack 404 to move. Wheels 116C slide in a direction towards the midpoint of system 100. Wheel 116C of front section 200 pushes upper gear rack 402 toward rear end 300. Wheel 116C of rear section 300 pushes lower gear 404 toward front section 200. Upper gear rack 402 and lower gear rack 404 substantially overlap, reducing the distance between folding supports 106 of front section 200 and folding supports 106 of rear section. At 750, as upper gear rack 402 and lower gear rack 404 move horizontally, gear 406 is rotated in a clockwise direction due to engagement of gear teeth 412 with upper rack teeth 408 and lower rack teeth 410. At 760, rotation of gear 406 in clockwise direction causes shaft 414 to rotate in a clockwise direction. At 770, shaft 414 extends into dynamo 418 as a receiving axle for dynamo 418, inputting rotational movement into dynamo 418 and converting mechanical rotation into a pulsing direct electrical current that can be utilized for power generation. Shaft 414 may include an automatic transmission box 416 which may aid in transferring rotational movement of shaft 414 into electrical power.

FIG. 8 is a flowchart generally illustrating the operational steps of a generator system where load L is removed. Referring to FIG. 8, when load L is removed from system 100, upper section 102 of system is lifted back to expanded position 600 while scissor arms 108a, 108b return to their retracted position and gear 406 rotates on gear racks 402, 404 returning to initial position without rotating shaft 414 in the axis of gear 406.

At 810, load L is removed from upper support 102 of system 100. At 820, upper support 102 moves in an upward direction to default position 600. Lifting of upper support 102 may be accomplished by means of springs, a motor that uses a portion of the energy generated by the shaft or mechanically using the weight of load L as it is removed from system 100. At 830, upward movement of upper support 102 causes folding supports 106 to expand. Expansion of folding supports 106 includes scissor arms 108a, 108b pivoting about pivotable hinge 110 to expand to distance D1 between upper support 102 and lower support 104. Wheels 116 slide in upper track 112 and lower track 114 to reduce horizontal distance H2 between adjacent wheels 116. At 840, as wheels 116 slide along tracks 112, 114, wheels 116C attached to gear rack assembly 400 cause upper gear rack 402 and lower gear rack 404 to move. Wheels 116C slide in a direction toward the respective terminal ends 120 of front section 200 and rear section 300. Wheel 116C of front section 200 pulls upper gear rack 402 toward terminal end 120 of front section 200. Wheel 116C of rear section 300 pulls lower gear rack 404 toward terminal end 120 of rear section 300. At 850, as upper gear rack 402 and lower gear rack 404 move, gear 406 is rotated in a counterclockwise direction due to engagement of gear teeth 412 with upper rack teeth 408 and lower rack teeth 410. As gear 406 rotates in counterclockwise direction, shaft 414 does not rotate with gear 406.

The present disclosure relates to a generator system 100 utilizing the weight of loads L that are present in a certain area for a certain period of time on a recurrent basis. That is, loads that undergo recurrent loading and unloading. Examples of such loads include, but are not limited to, vehicles in parking, ports, airports, etc., cargo/merchandise on top of ships, trucks, trains, etc., luggage/cargo/merchandise in stores, airports, ports, etc., people seated in theatres, polyvalent rooms, stadiums, waiting areas etc. or in vehicles, bicycles, chairs etc. and water in rivers or accumulated rainwater. The term load in this context includes, but is not limited to, vehicular and non-vehicular loads, where vehicular loads include land, air and water vehicles such as bicycles, automobiles, trucks, trains, ships, helicopters and airplanes. Non-vehicular loads include but are not limited to cargo, merchandise, luggage, animals, people and water.

The present disclosure relates to a generator system 100 which may be used in spaces with existing infrastructure, limiting the need for additional and expensive real estate for power generation. For example, where a bridge may exist and receives recurrent static loads of vehicles, the disclosed power generation system may be built into existing bridge with the same footprint of existing bridge such that additional real estate is not needed. Below description refers to examples of system 100 in existing locations and infrastructure for power generation.

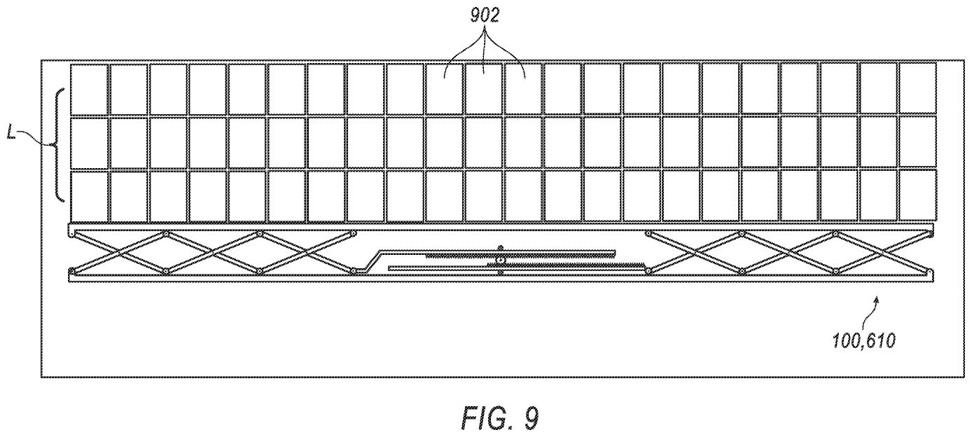

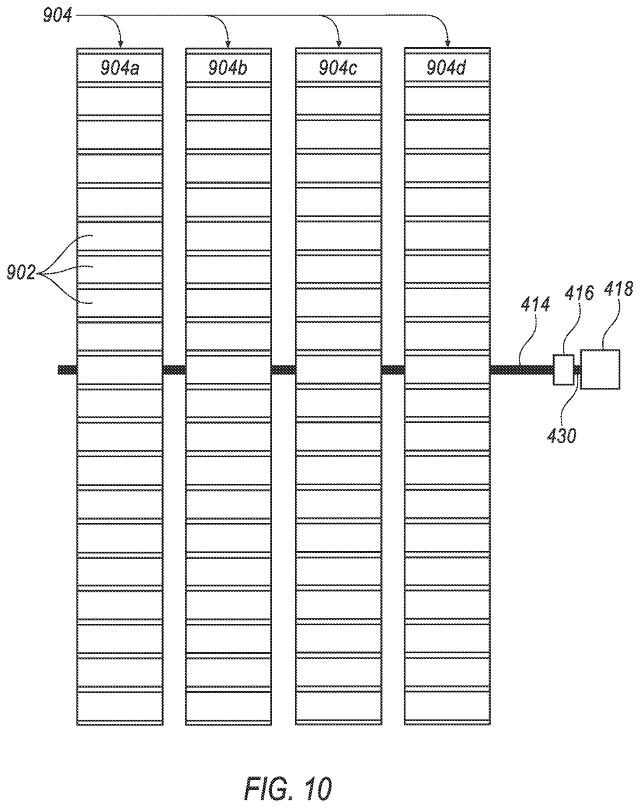

Referring to FIGS. 9 and 10, an application of the generator system 100 is illustrated which utilizes cargo as load L which may be stored, for example, at a port. Ports already include cargo storing areas. System 100 may be implemented in existing cargo storing areas such that additional real estate is not needed, or only minimally so. Load L includes a plurality of shipping containers 902 which are positioned on upper support 102 of system 100. System 100 is illustrated in a compressed position 610 as described above in FIG. 6B. As load L is positioned on upper support 102 of system, weight of shipping containers 902 causes system 100 to compress as described above in the steps of FIG. 7 which occur when load L is positioned on system 100 and system 100 moves from expanded position 600 to compressed position 610 and generates power. FIG. 10 illustrates system 100 from a top-view. System 100 may include a plurality of rows 904 of shipping containers 902 acting as load L. Shaft 414 extends from a first row 904A of the plurality of rows 904 and extends past each row 904B, 904C, 904D. Shaft 414 is connected to automatic transmission box 416 and dynamo 418 for converting rotational movement of shaft 414 into electrical power as shaft 414 rotates due to downward movement of upper support 102 caused by weight of load L.

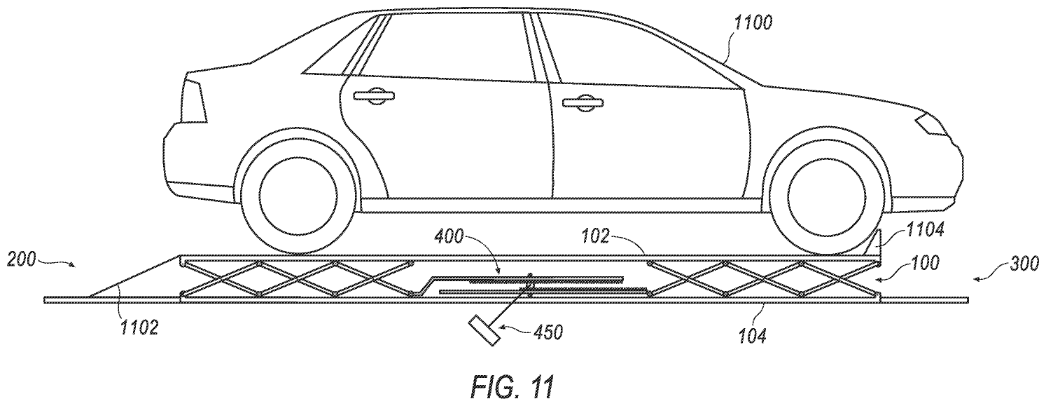

Referring to FIG. 11, an application of the generator system 100 is illustrated which utilizes a vehicle 1100 as load L. System 100 includes a ramp 1102 on front section 200 for vehicle 1100 to drive up onto upper support 102. Upper support 102 may include a stopper 1104 such as a barricade on rear section 300 to prevent vehicle 1100 from falling off upper support 102 or it may include an additional ramp to drive off upper support 102. As vehicle 1100 drives onto upper support 102, weight of vehicle 1100 begins compression of system 100 and power generation as described above. System 100 may be used in locations such as parking lots or garages where existing spaces exists for vehicles 1100 to park such that additional real estate is not required.

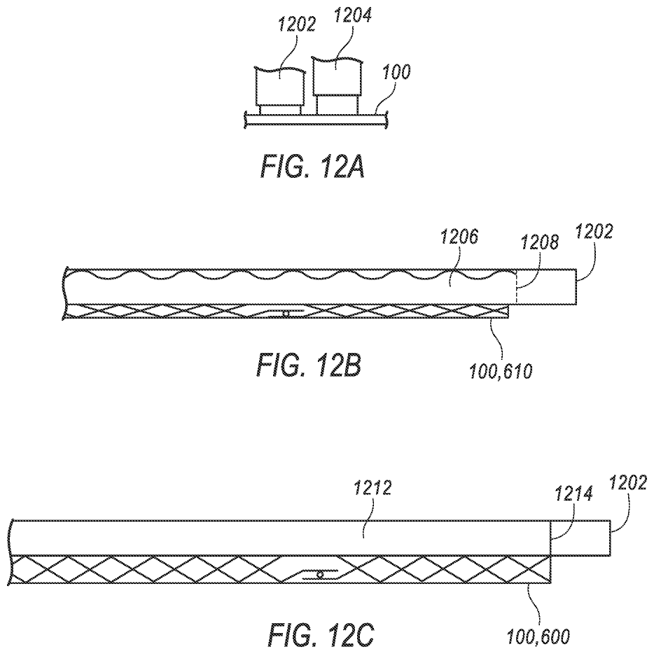

Referring to FIGS. 12A-12C, an application of the generator system 100 is illustrated which utilizes the weight of water 1206 in a channel 1202, 1204 as load L. A portion of river 1200 may include two channels 1202, 1204 carried on system 100. A first channel 1202 may include an open gate 1208 for filling first channel 1202 with water 1206. System 100 compresses and generates power as described above under weight of water 1206 acting as load L. Second channel 1204 may have a closed gate 1214 preventing water from entering second channel 1204 such that system 100 is in expanded position 600. First channel 1202 may then close gate 1206 to empty water 1206 and return to expanded position 600 while second channel 1204 opens gate 1208 to receive water 1206 and move to compressed position 610 to generate power.

Therefore, according to the disclosure, when load L is added to upper support 102, weight of L lowers upper support 102 such that scissor arms 108 expand in horizontal direction by wheels 116 sliding in tracks 112, 114. As wheels 116 slide in tracks 112, 114, upper gear rack 402 and lower gear rack 404 are pushed towards a midpoint of system 100, rotating gear 412 and shaft 414 such that rotational movement from shaft is transferred to dynamo 418 for power generation.

Thus, according to the disclosure, a generator system configured to support a load and create electrical power includes a plurality of folding supports, a gear rack assembly positioned at a midpoint of the system, and a generator assembly. The system includes an upper support movable in an upward and a downward direction and a lower support that is fixed and extends parallel to the upper support. The plurality of folding supports includes at least two corresponding pairs of scissor arms, an upper track and a lower track, and a plurality of wheels for connecting the at least two pairs of scissor arms to the upper track and the lower track. The gear rack assembly includes an upper gear rack and a lower gear rack, a gear engaging the upper gear rack and the lower gear rack, and a shaft positioned at a center of the gear for rotating in a one-directional manner with the gear. The generator assembly includes a dynamo, the shaft connected to the dynamo for converting the one-directional rotational movement of the shaft into electrical power. When the load is added to the upper support, a weight of the load lowers the upper support such that the scissor arms expand in a horizontal direction by the plurality of wheels sliding in the upper track and the lower track, and the plurality of wheels push the upper gear rack and the lower gear rack, rotating the gear and the shaft, such that the rotational movement of the shaft is transferred to the dynamo for electrical power generation.

Also according to the disclosure, a system configured to generate power from supporting a load includes a lower support that is stationary and an upper support movable in an upward and a downward direction. The generator system includes at least two folding supports, a first folding support and a second folding support positioned on opposite ends of the system between the upper support and the lower support. The generator system includes a gear rack assembly positioned at a midpoint of the system between the first folding support and the second folding support, the gear rack assembly including an upper gear rack connected to the first folding support, a lower gear rack connected to the second folding support, and a gear for engaging the upper gear rack and the lower gear rack. The generator system includes a generator assembly including a shaft rotatable with the gear, the shaft connected to a dynamo for converting rotational movement of the shaft to electrical power. When the load is added to the upper support, a weight of the load lowers the upper support such that the folding supports expand in a horizontal direction and push the upper gear rack and the lower gear rack, rotating the gear and the shaft, such that the rotational movement of the shaft is transferred to the dynamo for electrical power generation.

According to the disclosure, a method of generating power includes positioning a load on an upper support of a system, the upper support configured to move in a downward direction under weight of the load, compressing a plurality of folding supports, the plurality of folding supports positioned between the upper support and a lower support, pushing a pair of gear racks attached to the plurality of folding supports in a horizontal direction, rotating a gear engaged with the pair of gear racks, rotating a shaft engaged with the gear, the shaft connected to a dynamo, and converting rotational movement of the shaft into electrical power at the dynamo.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

What is claimed is:

1. A generator system configured to support a load and create electrical power, the generator system comprising:
an upper support movable in an upward and a downward direction;
a lower support that is fixed and extends parallel to the upper support;
a plurality of folding supports, the plurality of folding supports including:
at least two corresponding pairs of scissor arms;
an upper track and a lower track; and
a plurality of wheels for connecting the at least two pairs of scissor arms to the upper track and the lower track;
a gear rack assembly positioned at a midpoint of the system, the gear rack assembly including:
an upper gear rack and a lower gear rack;
a gear engaging the upper gear rack and the lower gear rack; and
a shaft positioned at a center of the gear rotatable in a one-directional manner with the gear; and
a generator assembly, the generator assembly including:
a dynamo, the shaft connected the dynamo for converting the one-directional rotational movement of the shaft into electrical power;
wherein, when the load is added to the upper support, a weight of the load lowers the upper support such that the scissor arms expand in a horizontal direction by the plurality of wheels sliding in the upper track and the lower track, and the plurality of wheels push the upper gear rack and the lower gear rack, rotating the gear and the shaft, such that the rotational movement of the shaft is transferred to the dynamo for electrical power generation.

2. The generator system of claim 1, wherein:
a first pair of scissor arms of the at least two corresponding pairs of scissor arms includes a first scissor arm, a second scissor arm, and a pivotable hinge; and
the first scissor arm and the second scissor arm pivot about the pivotable hinge at the midpoint of the first scissor arm and the second scissor arm.

3. The generator system of claim 1, further including a front section of the system and a rear section of the system:
wherein the front section of the system and the rear section of the system are separated by the gear rack assembly; and
the first pair of scissor arms are positioned in the front section of the system and a second pair of scissor arms are positioned in the rear section of the system.

4. The generator system of claim 3, wherein the front section of the system includes more than one pair of scissor arms and the rear section of the system includes more than one pair of scissor arms.

5. The generator system of claim 1, wherein the upper track extends along a bottom surface of the upper support, and the lower track extends along a top surface of the lower support, such that the upper track and the lower track are positioned facing towards each other.

6. The generator system of claim 1, wherein the upper support and the lower support include a first terminal end of the front section of the system and a second terminal end of the rear section of the system; and
the first pair of scissor arms is connected to a fixed hinge at the first terminal end, and the second pair scissor arms is connected to a fixed hinge at the second terminal end.

7. The generator system of claim 3, wherein the first pair of scissor arms at the front section of the system is connected to the upper gear rack and the second pair of scissor arms at the rear section of the system is connected to the lower gear rack.

8. The generator system of claim 1, further including an upper pulley and a lower pulley;
the upper pulley positioned on the upper gear rack and connected to the gear; and
the lower pulley positioned on the lower gear rack and connected to the gear.

9. The generator system of claim 1, wherein the load is at least one of a vehicle, cargo, or water.

10. A system configured to generate power from supporting a load, the system comprising:
a lower support that is stationary and an upper support movable in an upward and a downward direction;
at least two folding supports, a first folding support and a second folding support positioned on opposite ends of the system between the upper support and the lower support;
a gear rack assembly positioned at a midpoint of the system between the first folding support and the second folding support, the gear rack assembly including an upper gear rack connected to the first folding support, a lower gear rack connected to the second folding support, and a gear for engaging the upper gear rack and the lower gear rack; and
a generator assembly including a shaft rotatable with the gear, the shaft connected to a dynamo for converting rotational movement of the shaft to electrical power
wherein, when the load is added to the upper support, a weight of the load lowers the upper support such that the folding supports expand in a horizontal direction and push the upper gear rack and the lower gear rack, rotating the gear and the shaft, such that the rotational movement of the shaft is transferred to the dynamo for electrical power generation.

11. The generator system of claim 10, wherein the downward direction of the upper support pivots the first folding support and the second folding support about a first pivotable hinge and a second pivotable hinge, such that the first folding support and the second folding support compress.

12. The generator system of claim 11, wherein compression of the first folding support and the second folding support expands the first folding support and the second folding support such that a plurality of wheels attached to the first folding support and the second folding support slide in an upper track and a lower track.

13. The generator system of claim 12, wherein expansion of the first folding support and the second folding support pushes the upper gear rack and the lower gear rack in a direction toward a midpoint of the system.

14. The generator system of claim 13, wherein pushing the upper gear rack and the lower gear rack in the direction toward the midpoint rotates the gear such that the shaft rotates.

15. The generator system of claim 1, further including a compressed position and an expanded position;
wherein the compressed position is permitted when the upper support moves in the downward direction and the expanded positioned is permitted when the upper support moves in the upward movement.

16. The generator system of claim 15, wherein the distance between the upper support and the lower support is greater in the expanded position than in the compressed position; and
the distance between where a first arm of the first folding support connects to the upper support and where a second arm of the first folding support connects to the upper support is greater in the compressed positioned than in the expanded position.

17. A method of generating power, comprising:
positioning a load on an upper support of a system, the upper support configured to move in a downward direction under weight of the load;
compressing a plurality of folding supports, the plurality of folding supports positioned between the upper support and a lower support;
pushing a pair of gear racks attached to the plurality of folding supports in a horizontal direction;
rotating a gear engaged with the pair of gear racks;
rotating a shaft engaged with the gear; the shaft connected to a dynamo; and
converting rotational movement of the shaft into electrical power at the dynamo.

18. The method of claim 17, wherein compressing the plurality of folding supports includes sliding a plurality of wheels connected to the folding supports in an upper track and a lower track and pivoting the plurality of folding supports about a pivotable hinge.

19. The method of claim 17, wherein rotating the shaft is permitted as the gear rotates in one direction and is prohibited as the gear rotates in a second direction.

20. The method of claim 17, wherein removing the load from the upper support permits the upper support to move in an upward direction to an expanded position.
